(19) United States
(12) Patent Application Publication
(10) Pub. No.: US 2023/0183410 A1
(43) Pub. Date: Jun. 15, 2023

(54) ACTIVE ENERGY RAY CURING COMPOSITION, ACTIVE ENERGY RAY CURING INK COMPOSITION, ACTIVE ENERGY RAY CURING INKJET INK COMPOSITION, COMPOSITION CONTAINER, APPARATUS FOR FORMING TWO-DIMENSIONAL OR THREE-DIMENSIONAL IMAGE, METHOD OF FORMING TWO-DIMENSIONAL OR THREE-DIMENSIONAL IMAGE, CURED MATTER, AND DECORATIVE OBJECT

(71) Applicants: Hikaru ISHII, Kanagawa (JP); Satoshi KOJIMA, Kanagawa (JP); Yuusuke FUJITA, Tokyo (JP)

(72) Inventors: Hikaru ISHII, Kanagawa (JP); Satoshi KOJIMA, Kanagawa (JP); Yuusuke FUJITA, Tokyo (JP)

(73) Assignee: Ricoh Company, Ltd., Tokyo (JP)

(21) Appl. No.: 18/065,401

(22) Filed: Dec. 13, 2022

(30) Foreign Application Priority Data
Dec. 15, 2021 (JP) 2021-203716

(51) Int. Cl. C08F 283/00; C08K 5/5415; C09D 11/102; C09D 151/08

(52) U.S. Cl. CPC C08F 283/006; C08K 5/5415; C09D 11/102; C09D 151/08

(57) ABSTRACT

An active energy ray curing composition contains a urethane acrylate oligomer (A) having three or more polymerizable functional groups, a polyfunctional monomer (B) having three or more polymerizable functional groups, a monofunctional monomer (C), and a surfactant (D) having a siloxane bond, wherein the urethane acrylate oligomer (A) has a glass transition temperature of 85 degrees C. or lower, wherein the urethane acrylate oligomer (A) has a weight average molecular weight of from 1,000 to 9,000, wherein the polyfunctional monomer (B) accounts for 22.0 to 60.0 percent by mass of the entire of the active energy ray curing composition.

### CROSS-REFERENCE TO RELATED APPLICATIONS

This patent application is based on and claims priority pursuant to 35 U.S.C. § 119 to Japanese Patent Application No. 2021-203716, filed on Dec. 15, 2021, in the Japan Patent Office, the entire disclosure of which is hereby incorporated by reference herein.

### BACKGROUND

### Technical Field

The present disclosure is related to an active energy ray curing composition, active energy ray curing ink composition, active energy ray curing inkjet ink composition, a composition container, an apparatus for forming a two-dimensional or three-dimensional image, a method of forming a two-dimensional or three-dimensional image, cured matter, and a decorative object.

### Description of the Related Art

Active energy ray curing compositions that cure upon irradiation of active energy rays are required to demonstrate a better drying property, achieve more excellent attachability to an inorganic substrate such as glass, and form a stronger film, i.e., cured matter, of the composition on the substrate than solvent-based ink compositions.

### SUMMARY

According to embodiments of the present disclosure, an active energy ray curing composition is provided which contains a urethane acrylate oligomer (A) having three or more polymerizable functional groups, a polyfunctional monomer (B) having three or more polymerizable functional groups, a monofunctional monomer (C), and a surfactant (D) having a siloxane bond, wherein the urethane acrylate oligomer (A) has a glass transition temperature of 85 degrees C. or lower, wherein the urethane acrylate oligomer (A) has a weight average molecular weight of from 1,000 to 9,000, wherein the polyfunctional monomer (B) accounts for 22.0 to 60.0 percent by mass of the entire of the active energy ray curing composition.

As another aspect of the present disclosure, an active energy ray curing ink composition is provided which contains the active energy ray curing composition mentioned above.

As another aspect of the present disclosure, a composition container is provided which includes a container containing the active energy ray curing composition mentioned above, an active energy ray curing ink composition containing the active energy ray curing composition, or an active energy ray curing inkjet ink composition containing the active energy ray curing ink composition.

As another aspect of the present disclosure, an apparatus for forming a two-dimensional or three-dimensional image is provided which includes an accommodating unit containing the active energy ray curing composition mentioned above, an active energy ray curing ink composition containing the active energy ray curing composition, or the active energy ray curing inkjet ink composition containing the active energy ray curing ink composition, and an irradiator configured to emit active energy rays.

As another aspect of the present disclosure, a method of forming a two-dimensional or three-dimensional image is provided which includes exposing the active energy ray curing composition mentioned above, an active energy ray curing ink composition containing the active energy ray curing composition, or an active energy ray curing inkjet ink composition containing the active energy ray curing ink composition to active energy rays.

As another aspect of the present disclosure, cured matter is provided which is produced by a method of exposing the active energy ray curing composition mentioned above, an active energy ray curing ink composition containing the active energy ray curing composition, or an active energy ray curing inkjet ink composition containing the active energy ray curing ink composition to active energy rays. As another aspect of the present disclosure, a decorative object is provided which includes a substrate and a surface decoration of the cured matter mentioned above on the substrate.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating the image forming apparatus according to an embodiment of the present disclosure;

FIG. 2 is a schematic diagram illustrating the image forming apparatus according to another embodiment of the present disclosure;

FIG. 3A is a schematic diagram illustrating the image forming apparatus according to another embodiment of the present disclosure;

FIG. 3B is a schematic diagram illustrating the image forming apparatus according to another embodiment of the present disclosure;

FIG. 3C is a schematic diagram illustrating the image forming apparatus according to another embodiment of the present disclosure; and

FIG. 3D is a schematic diagram illustrating the image forming apparatus according to another embodiment of the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, an active energy ray curing composition is provided which has excellent inkjet discharging stability and forms cured matter that strikes a balance between the attachability to a glass substrate and the strength of applied film while the cured matter has an excellent resistance to alcohol.

Active Energy Ray Curing Composition

The active energy ray curing composition of the present disclosure contains a urethane acrylate oligomer (A) having three or more polymerizable functional groups, a polyfunctional monomer (B) having three or more polymerizable functional groups, a monofunctional monomer (C), a surfactant (D) having a siloxane bond, and other optional substances including a polymerization initiator, coloring material, and an organic solvent.

In the present specification, the urethane acrylate oligomer (A) having three or more polymerizable functional groups is also referred to as the component (A), the polyfunctional monomer (B) having three or more polymerizable functional groups, the component (B), the monofunctional monomer (C), the component (C), and the surfactant (D) having a siloxane bond, the component (D).

Typical active energy ray curing compositions as described in Japanese Unexamined Patent Application Publication No. 2006-257155 and WO2019/142657 involve a problem of applied film (or cured matter) weakening when the applied film obtained by curing is softened by increasing the ratio of a monofunctional monomer and bi-functional monomer in a typical active energy ray curing composition in order to enhance the attachability to a substrate. Also, if a cross-linking component such as a polyfunctional monomer or polyfunctional oligomer or a resin is added to such a typical active energy ray curing composition to enhance the strength of applied film, the internal stress to the applied film increases, which degrades the attachability to a substrate and the resistance to cracking of the applied film. In general, there is trade-off between the attachability of an active energy ray curing composition to a substrate and the strength of applied film thereof. This trade-off makes it difficult to strike a balance between both properties.

In addition, an active energy ray curing composition is likely to become sticky when a polyfunctional monomer and a reactive polyfunctional olygomer are used in combination or a polymer resin is added. This sticky composition tends to cause a problem of inkjet discharging when the active energy ray curing composition is used as an active energy ray curing ink composition.

The ink composition disclosed in Japanese Unexamined Patent Application Publication No. 2021-070731 invites a problem of poor resistance to alcohol because a polymerizable compound having a polar group is used as the main component of the ink composition.

The active energy ray curing composition of the present disclosure is based on the knowledge described above.

As a result of the investigation, the inventors of the present invention have formulated an active energy ray curing composition that strikes a balance between the attachability to a glass substrate and the strength of applied film (i.e., cured matter) while the cured matter has an excellent resistance to alcohol by containing a urethane acrylate oligomer (A) having three or more polymerizable functional groups, a polyfunctional monomer (B) having three or more polymerizable functional groups, a monofunctional monomer (C), and a surfactant (D) having a siloxane bond, and regulating their number of functional groups, glass transition temperature, weight average molecular weight, and the proportion in the active energy ray curing composition. The composition also has excellent inkjet discharging stability.

In the present disclosure, the active energy ray curing composition contains a urethane acrylate oligomer (A) having three or more polymerizable functional monomers, a polyfunctional monomer (B) having three or more polymerizable functional monomers, a monofunctional monomer (C), and a surfactant (D) having a siloxane bond, wherein the urethane acrylate oligomer (A) has a glass transition temperature of 85 degrees C. or lower, wherein the urethane acrylate oligomer (A) has a weight average molecular weight of from 1,000 to 9,000, wherein the polyfunctional monomer (B) accounts for 22.0 to 60.0 percent by mass of the active energy ray curing composition. Therefore, the active energy ray curing composition strikes a balance between the attachability to a glass substrate and the strength of applied film (i.e., cured matter) while the cured matter has an excellent resistance to alcohol and the active energy ray curing composition has excellent inkjet discharging stability.

Urethane Acrylate Oligomer (A) Having Three or More Polymerizable Functional Monomers

The urethane acrylate oligomer (A) having three or more polymerizable functional groups in the active energy ray curing composition of the present disclosure has a glass transition temperature of 85 degrees C. of lower and a weight average molecular weight of from 1,000 to 9,000.

“Three or more polymerizable functional groups” means three or more polymerizable functional groups present in a molecule.

By containing the urethane acrylate oligomer (A) having a number of functional groups, a glass transition temperature, and a weight average molecular weight in the ranges specified above, the active energy ray curing composition can form cured matter that strikes a balance between the softness affecting the attachability to a glass substrate and the strength of applied film.

Number of Polymerizable Functional Groups

The number of polymerizable functional groups of the urethane acrylate oligomer (A) is not particularly limited as long as it is three or more and can be suitably selected to suit to a particular application. Preferably, the number is from 3 to 9 to enhance the attachability to a substrate and the strength of applied film.

When the number is three or more, the attachability of an active energy ray curing composition to a substrate is excellent.

When the number is nine or less, cured matter, i.e., applied film, becomes firm.

Glass Transition Temperature

The glass transition temperature of the urethane acrylate oligomer (A) is not particularly limited as long as it is 85 degrees C. or lower and can be suitably selected to suit to a particular application. Preferably, the glass transition temperature is from 31 to 85 degrees C. to strike a balance between the attachability to a substrate and the strength of applied film.

A glass transition temperature of the urethane acrylate oligomer of 31 degrees C. or higher is preferable because it enhances the attachability of an active energy ray curing composition to a substrate.

A glass transition temperature of the urethane acrylate oligomer of 85 degrees C. or lower is preferable because it enhances the strength of cured matter or applied film.

The method of measuring the glass transition temperature of the urethane acrylate oligomer (A) is not particularly limited and can be suitably selected to suit to a particular application. For example, the glass transition temperature can be measured with a differential scanning calorimeter (DSC-60, manufactured by Shimadzu Corporation).

Weight Average Molecular Weight

The weight average molecular weight of the urethane acrylate oligomer (A) is not particularly limited as long as it is from 1,000 to 9,000 and can be suitably selected to suit to a particular application. Preferably, the weight average molecular weight is preferably from 1,000 to 4,000 and more preferably from 1,000 to 2,000 in terms of the attachability to a substrate and the discharging stability.

A weight average molecular weight of from 1,000 or more is preferable because the attachability to a substrate is excellent.

A weight average molecular weight of from 4,000 or more is preferable because the discharging stability is excellent.

The method of measuring the weight average molecular weight of the urethane acrylate oligomer (A) is not particularly limited and can be suitably selected to suit to a particular application. For example, the weight average molecular weight can be measured by a method such as liquid chromatograph-mass spectrometry or gas chromatograph-mass spectrometry.

The proportion of the urethane acrylate oligomer (A) is not particularly limited and can be suitably selected to suit to a particular application. Preferably, it is from 3.0 to 6.0 percent by mass to the entire of the active energy ray curing composition to achieve an excellent continuous discharging stability.

The urethane acrylate oligomer (A) can be suitably synthesized or procured.

The method of synthesizing the urethane acrylate oligomer (A) is not particularly limited and can be suitably selected to suit to a particular application.

Specific examples of the urethane acrylate oligomer (A) include, but are not limited to EBECRYL294/25HD, EVECRYL4220, EVECRYL4513, EVECRYL4740, EVECRYL4820, EVECRYL8465, EVECRYL9260, EVECRYL9260, EVECRYL8701, KRM8667, EVECRYL4666, EVECRYL8405, EVECRYL210, and EVECRYL220 (all manufactured by DAICEL-ALLNEX LTD.), and CN series such as CN8885NS (manufactured by Sartomer Company).

Polyfunctional Monomer (B) Having Three or More Polymerizable Functional Groups

The proportion of the polyfunctional monomer (B) having three or more functional groups contained in the entire of the active energy ray curing composition of the present disclosure is from 22.0 to 60.0 percent by mass.

“Three or more polymerizable functional groups” means three or more polymerizable functional groups present in a molecule.

The active energy ray curing composition of the present disclosure containing the polyfunctional monomer (B) can form cured matter or applied film having a firm cross-linking structure.

The polyfunctional monomer (B) is not particularly limited and can be suitably selected to suit to a particular application. It preferably has an unsaturated bond derived from (meth)acryloyl group as functional group to increase the curing speed and provide more options for polymerization initiators and monomers.

Specific examples of the polyfunctional monomer (B) include, but are not limited to, pentaerythritol tri(meth)acrylate, pentaerythritol tetra(meth)acrylate, dipentaerythritol tetra(meth)acrylate, trimethylolpropane tri(meth)acrylate, tetramethylolmethane tetra(meth)acrylate, trimethylolethane tri(meth)acrylate, trimethylolpropane tri(meth)acrylate, bis(4-(meth)acryloxypolyethoxyphenyl)propane, diallyl phthalate, triallyl trimellitate, 1,6-hexanediol di(meth)acrylate, 1,9-nonanediol di(meth)acrylate, 1,3-butylene glycol di(meth)acrylate, 1,10-decanediol di(meth)acrylate, hydroxypivalic acid neopentyl glycol di(meth)acrylate, tetramethylolmethane tri(meth)acrylate, dimethyloltricyclodecane di(meth)acrylate, modified glycerin tri(meth)acrylate,

an adduct of bisphenol A with diglycidyl ether(meth)acrylic acid, modified bisphenol A di(meth)acrylate, dipentaerythritol hexa(meth)acrylate, pentaerythritol tri(meth)acrylate tolylene diisocyanate urethane prepolymer, pentaerythritol tri(meth)acrylate hexamethylene diisocyanate urethane prepolymer, ditrimethylolpropane tetra(meth)acrylate, and pentaerythritol tri(meth)acrylate hexamethylene diisocyanate urethane prepolymer. These can be used alone or in combination.

In the present specification, “(meth)acrylic” means methacrylic acid or acrylic acid, “(meth)acryloyl” means methacryloyl or acryloyl, and “(meth)acrylate” means methacrylic acid ester or acrylic acid ester.

Number of Polymerizable Functional Groups

The number of polyfunctional monomer (B) is not particularly limited as long as it is three or more and can be suitably selected to suit to a particular application. Preferably, the number is 3 to obtain cured matter striking a balance between the attachability to a substrate and the strength of applied film.

The proportion of the polyfunctional monomer (B) to the entire of the active energy ray curing composition mentioned above is not particularly limited as long as it is within a range of from 22.0 to 60.0 percent by mass and can be suitably selected to suit to a particular application. It is preferably from 22.0 to 45.0 percent by mass to enhance the strength of applied film, the attachability to a substrate, and the continuous discharging stability.

A proportion of the polyfunctional monomer (B) to the entire of the active energy ray curing composition mentioned above of 22.0 percent by mass or greater is preferable to achieve a sufficient strength of applied film.

A proportion of the polyfunctional monomer (B) to the entire of the active energy ray curing composition mentioned above of 45.0 percent by mass or less prevents the degradation of the attachability of cured matter formed by curing the active energy ray curing composition to a substrate and enhances the continuous discharging stability of the active energy ray curing composition.

The active energy ray curing composition of the present disclosure preferably contains two or more types of polyfunctional monomers to form the cross-linking structure in many directions, thereby enhancing the strength of applied film.

When the active energy ray curing composition of the present disclosure preferably contains two or more types of polyfunctional monomers, it is suitable to contain at least one type of the polyfunctional monomer (B) having three or more functional groups satisfying the number of polymerizable functional groups and proportion mentioned above. The number of polymerizable functional groups and proportion of the other polyfunctional monomers are not particularly limited.

In the present specification, a polyfunctional monomer having three or more polymerizable functional groups within a molecule and a proportion of from 22.0 to 60.0 percent by mass to the active energy ray curing composition mentioned above is referred to as the polyfunctional monomer (B) having three or more polymerizable functional groups or the polyfunctional monomer (B). A polyfunctional monomer not limiting its number of polymerizable functional groups or proportion is referred to as just a polyfunctional monomer. The polyfunctional monomer includes the polyfunctional monomer (B) having three or more functional groups.

The polyfunctional monomer (B) can be synthesized or procured.

The method of synthesizing the polyfunctional monomer (B) is not particularly limited and can be suitably selected to suit to a particular application.

The products of the polyfunctional monomer (B) can be suitably selected to suit to a particular application. Specific examples include, but are not limited to, VISCOAT #295 (trimethylol propane acrylate, TMPTA, manufactured by OSAKA ORGANIC CHEMICAL INDUSTRY LTD.), SR508 (dipropylene glycol diacrylate diacrylate, DPGDA), and SR295 (pentaerythritol tetraacrylate, PETA) (both manufactured by Sartomer Company).

Monofunctional Monomer (C)

The active energy ray curing composition of the present disclosure contains the monofunctional monomer (C).

The monofunctional monomer (C) contained in the active energy ray curing composition of the present disclosure enables the active energy ray curing composition to melt a substrate, thereby obtaining cured matter or applied film having an excellent attachability to the substrate.

The monofunctional monomer (C) in the present disclosure refers to a monomer having a polymerizable functional group in a molecule.

The monofunctional monomer (C) is not particularly limited and can be suitably selected to suit to a particular application. It preferably has an unsaturated bond derived from (meth)acryloyl group as functional group to increase the curing speed and provide more options for polymerization initiators and monomers.

The monofunctional monomer (C) contained in the active energy ray curing composition of the present disclosure is not particularly limited and can be suitably selected to suit to a particular application.

Specific examples include, but are not limited to, phenoxyethyl acrylate, isobornyl acrylate, 2-hydroxyethyl acrylate, 4-hydroxybutyl acrylate, isobutyl acrylate, t-butyl acrylate, isooctyl acrylate, 2-methoxyethyl acrylate, methoxytriethylene glycol acrylate, 2-ethoxyethyl acrylate, 3-methoxybutyl acrylate, ethoxyethyl acrylate, butoxyethyl acrylate, ethoxydiethylene glycol acrylate, methoxydixylethyl acrylate, ethyldiglycol acrylate, imide acrylate, isoamyl acrylate, ethoxylated succinic acid acrylate, trifluoroethyl acrylate, ω-carboxypolycaprolactone monoacrylate, tetrahydrofurfuryl (meth)acrylate, (meth)acryloylmorpholine, N-vinylcaprolactam, N-vinylpyrrolidone, N-(meth)acryloyloxyethyl hexahydrophthalimide, cyclic trimethylolpropane formal (meth)acrylate, N-vinyl formamide, cyclohexyl acrylate, benzyl acrylate, methylphenoxyethyl acrylate, 4-t-butylcyclohexyl acrylate, caprolactone-modified tetrahydrofurfuryl acrylate, tribromophenyl acrylate, ethoxylated tribromophenyl acrylate, 2-phenoxyethyl acrylate, phenoxydiethylene glycol acrylate, 2-hydroxy-3-phenoxypropyl acrylate, 1, 4-cyclohexanedimethanol monoacrylate, 2-(2-ethoxyethoxy)ethyl acrylate, stearyl acrylate, diethylene glycol monobutyl ether acrylate, lauryl acrylate, isodecyl acrylate, 3,3,5-trimethylcyclohexyl acrylate, isooctyl acrylate, octyl/decyl acrylate, tridecyl acrylate, caprolactone acrylate, ethoxylated (4) nonylphenol acrylate, methoxypolyethylene glycol (350) monoacrylate, and methoxypolyethylene glycol (550) monoacrylate. Of these, a monofunctional monomer having a heterocyclic structure is preferable for an active energy ray curing composition to dissolve a substrate, thereby obtaining cured matter or applied film having an excellent attachability to the substrate.

The monofunctional monomer having a heterocyclic structure is not particularly limited and can be suitably selected to suit to a particular application.
Specific examples include, but are not limited to, tetrahydrofurfuryl (meth)acrylate, (meth)acryloylmorpholine, N-vinylcaprolactam, N-vinylpyrrolidone, N-(meth)acryloyloxyethyl hexahydrophthalimide, and cyclic trimethylolpropane formal (meth)acrylate.

These can be used alone or in combination.

The proportion of the monofunctional monomer (C) is not particularly limited and can be suitably selected to suit to a particular application. The proportion of the monofunctional monomer (C) to the entire of the active energy ray curing composition is preferably from 10.0 to 60.0 percent by mass and more preferably from 10.0 to 45.0 percent to achieve an excellent attachability to a substrate and an excellent strength of applied film.

A proportion of the monofunctional monomer (C) to the entire of an active energy ray curing composition mentioned above of 10.0 percent by mass or greater is preferable to obtain cured matter having an excellent attachability to a substrate.

A proportion of the monofunctional monomer (C) to the entire of an active energy ray curing composition of 60.0 percent by mass or less is preferable to obtain cured matter or applied film having an excellent strength.

The monofunctional monomer (C) can be synthesized or procured.

The method of synthesizing the monofunctional monomer (C) is not particularly limited and can be suitably selected to suit to a particular application.

The marketed product of the monofunctional monomer (C) is not particularly limited and can be suitably selected to suit to a particular application.

Specific examples include, but are not limited to, Viscoat #152 (tetrahydrofurfuryl acrylate (THFA), Viscoat #200 (cyclic trimethylolpropane formal acrylate (CTFA), Viscoat #192 (phenoxyethyl acrylate (PEA), and IBXA (isobornyl acrylate (IBXA), all manufactured by OSAKA ORGANIC CHEMICAL INDUSTRY LTD.), and ACMO (acryloylmorpholine (ACMO), manufactured by KJ Chemicals Co., Ltd.).

Surfactant (D) Having Siloxane Bond

The active energy ray curing composition of the present disclosure contains the component (A), the component (B), the component (C), and the surfactant (D) having a siloxane bond as a surface tension controlling agent adjuster.

The active energy ray curing composition of the present disclosure containing the surfactant (D) having a siloxane bond can demonstrate physical properties including surface tension suitable for inkjet discharging.

Number of Polymerizable Functional Group

The number of functional groups of the surfactant (D) having a siloxane bond is not particularly limited and can be suitably selected to suit to a particular application. It is preferably 4 or less to obtain cured matter of applied film having an excellent resistance to alcohol.

The proportion of the surfactant (D) having a siloxane bond to an active energy ray curing composition is preferably from 0.01 to 2.0 percent by mass and more preferably from 0.1 to 1.0 percent by mass.

A proportion of the surfactant (D) to the entire of an active energy ray curing composition of 2.0 percent by mass or less is preferable to avoid non-dissolution or foaming.

The surfactant (D) can be synthesized or procured.

The method of synthesizing the surfactant (D) is not particularly limited and can be suitably selected to suit to a particular application.

The marketed product of the surfactant (D) is not particularly limited and can be suitably selected to suit to a particular application.

Specific examples include, but are not limited to, BYK-300, BYK-302, BYK-306, BYK-307, BYK-310, BYK-315, BYK-320, BYK-322, BYK-323, BYK-325, BYK-330, BYK-331, BYK-333, BYK-337, BYK-344, BYK-370, BYK-375, BYK-377, BYK-UV3500, BYK-UV3510, BYK-UV3570 (all manufactured by BYK-Chemie Co., Ltd.), TEGO-TWIN4000, TEGO-WETKL245, TEGO-WET270, TEGO-WET280, TEGO-RAD2100, TEGO-RAD2200N, TEGO-RAD2250, TEGO-RAD2300, TEGO-RAD2500, TEGO-RAD2600, and TEGO-RAD2700, all manufactured by Evonik Industries AG. Of these, TEGO-RAD2200N, TEGO-RAD2250, TEGO-RAD2300, and TEGO-RAD2500, all of which have 4 or less functional groups, are preferable. These can be used alone or in combination.

The proportion of the total of the containing a urethane acrylate oligomer (A), the polyfunctional monomer (B), the monofunctional monomer (C), and the a surfactant (D) to the entire of the active energy ray curing composition mentioned above is preferably from 89.9 to 94.99 percent by mass.

Polymerization Initiator

The active energy ray curing composition of the present disclosure may contain a polymerization initiator.

The polymerization initiator is not particularly limited as long as it produces active species such as a radical or a cation upon an application of energy of active energy rays, which initiates polymerization of a polymerizable compound (monomer or oligomer).

The polymerization initiator is not particularly limited and can be suitably selected to suit to a particular application. It includes a radical polymerization initiator, a cation polymerization initiator, and a base producing agent. Of these, radical polymerization initiators are preferable to have more options for materials. These can be used alone or in combination.

The radical polymerization initiator is not particularly limited and can be suitably selected to suit to a particular application.

Specific examples include, but are not limited to, aromatic ketones, acylphosphineoxide compounds, aromatic oniumchlorides, organic peroxides, thio compounds such as thioxanthone compounds, compounds including thiophenyl groups, hexaarylbiimidazole compounds, ketoxime-esterified compounds, borate compounds, azinium compounds, metallocene compounds, active ester compounds, compounds having a carbon halogen bond, and alkylamine compounds.

Specific examples include, but are not limited to, benzophenone, acetophenone, 2-hydroxy-2-phenylacetophenone, 2-ethoxy-2-phenyl acetophenone, 2-methoxy-2-phenyl acetophenone, 2-isopropoxy-2-phenyl acetophenone, 2-isobutoxy-2-phenyl acetophenone, 4-methoxy acetophenone, 4-benzyloxy acetophenone, 4-phenyl acetophenone, 4-benzoyl 4′-methyl diphenyl sulfide, a derivative of an oligomer [benzene, (1-methylethynyl)-, homopolymer, ar-(2-hydroxy-2-methyl-1-oxopropyl) of ethyl benzoylformate2-hydroxy-1-(4-isopropenyl phenyl)-2-methylpropane-1-one, (Esacure ONE, manufactured by IGM Resins B.V.), 2-benzyl-2-dimethylamino-1-(4-morpholinophenyl)-butanone-1 (Irgacure 369), bis(2,4,6-trimethyl benzoyl)phenylphosphine oxide (Irgacure 819), 2,4,6-trimethyl benzoyl diphenylphosphine oxide (Irgacure TPO), polyethylene glycol 200-di(β-4(4-(2-dimethyl amino-2-benzyl)butanonylphenyl)piperazine (Omnipol 910, manufactured by IGM Resins B.V.), and 1,3-di({α-[1-chloro-9-oxo-9H-thioxanthen-4-yl)oxy]acetylpoly[oxy(1-methylethylene)]}oxy)-2,2-bis({α-[1-chloro-9-oxo-9H-thioxanthen-4-yl)oxy]acetylpoly[oxy(1-methylethylene)]}oxymethyl)propane (Speedcure 7010, manufactured by Lambson Group Ltd.), polybutylene glycol bis(9oxo-9H-thioxanethunyloxy)acetate (Omnipoll TX, manufactured by IGM Resins B.V.), and thioxanthene polymer (Genepol TX-2, manufactured by Lahn AG.).

These can be used alone or in combination.

The radical polymerization initiator can be synthesized or procured.

The proportion of the polymerization initiator mentioned above to the entire of an active energy ray curing composition is preferably from 5 to 20 percent by mass and more preferably from 5 to 10 percent by mass to achieve a curing speed enough to cure the active energy ray curing composition.

A sensitizer (polymerization promoter) can be optionally used together with a polymerization initiator.

The polymerization promoter is not particularly limited and can be suitably selected to suit to a particular application.

Specific examples include, but are not limited to, amine compounds such as trimethyl amine, methyldimethanol amine, triethanol amine, p-diethylamino acetophenone, p-dimethylamino ethylbenzoate, p-dimethyl amino benzoate-2-ethylhexyl, N,N-dimethyl benzylamine, and 4,4′-bis(diethylamino)benzophenone.

The proportion of a polymerization promoter is suitably determined to suit to the type and the amount of the polymerization initiator to be used.

Coloring Material

The active energy ray curing composition of the present disclosure may contain a coloring material.

As the coloring material, depending on the objectives and requisites of the active energy ray curing composition in the present disclosure, various types of pigments and dyes can be used to impart black, white, magenta, cyan, yellow, green, orange, and gloss color such as gold and silver.

Pigments

The pigment is not particularly limited and can be suitably selected to suit to a particular application. It includes inorganic pigments and organic pigments. These can be used alone or in combination.

The inorganic pigment is not particularly limited and can be suitably selected to suit to a particular application.

Specific examples include, but are not limited to, carbon blacks (C.I. Pigment Black 7) such as furnace black, lamp black, acetylene black, and channel black, iron oxides, and titanium oxides.

The organic pigment is not particularly limited and can be suitably selected to suit to a particular application.

Specific examples include, but are not limited to, azo pigments such as insoluble azo pigments, condensed azo pigments, azo lakes, and chelate azo pigments, polycyclic pigments such as phthalocyanine pigments, perylene pigments, perinone pigments, anthraquinone pigments, quinacridone pigments, dioxane pigments, thioindigo pigments, isoindolinone pigments, and quinofuranone pigments, dye chelates such as basic dye type chelates and acid dye type chelates, dye lakes such as basic dye type lake and acid dye type lake, nitro pigments, nitroso pigments, aniline black, and daylight fluorescent pigments.

The active energy ray curing composition of the present disclosure may furthermore optionally contain a dispersant to enhance the dispersibility of the pigment mentioned above.

The dispersant is not particularly limited and can be suitably selected to suit to a particular application. It includes a dispersant such as a polymer dispersant generally used to prepare a pigment dispersion.

Dyes

The dye mentioned above is not particularly limited and can be suitably selected to suit to a particular application. It includes an acidic dye, direct dye, reactive dye, and basic dye. These can be used alone or in combination.

The proportion of the coloring material to the entire of an active energy ray curing liquid is not particularly limited and can be suitably determined to suit to a desired color density and dispersibility in the active energy ray curing liquid. It is preferably from 0.1 to 20 percent by mass.

The active energy ray curing composition of the present disclosure can be transparent without containing a coloring material. If the active energy ray curing composition is transparent, it can form an overcoating layer for protecting a formed image.

Organic Solvent

The active energy ray curing composition of the present disclosure may optionally contain an organic solvent, although it is preferable to spare it.

The organic solvent is not particularly limited and can be suitably selected to suit to a particular application. The organic solvent is preferably a composition free of a volatile organic compound (VOC) to enhance the safeness of handling the active energy ray curing composition of the present disclosure and prevent the environmental pollution.

“Organic solvent” in the present specification represents a non-reactive organic solvent such as ether, ketone, xylene, ethylacetate, cyclohexanone, or toluene, which is clearly distinguished from a reactive monomer.

“Sparing an organic solvent” means that the active energy ray curing composition of the present disclosure does not substantially contain an organic solvent, which is the proportion of an organic solvent to the entire of an active energy ray curing composition is less than 0.1 percent by mass.

Other Components

The active energy ray curing composition of the present disclosure may optionally contain other components in addition to each component mentioned above.

The other components are not particularly limited and can be suitably selected to suit to a particular application. Examples include, but are not limited to, polymerization inhibitors, leveling agents, defoaming agents, fluorescent brighteners, penetration-enhancing agents, wetting agents (humectants), fixing agents, viscosity stabilizers, fungicide, preservatives, antioxidants, ultraviolet absorbents, chelate agents, pH regulator, thickeners, and surfactants other than the surfactant (D).

The proportion of the other components is not particularly limited and can be suitably selected to suit to a particular application.

Polymerization Inhibitor

The polymerization inhibitor is not particularly limited and can be suitably selected to suit to a particular application. Specific examples include, but are not limited to, 4-methoxyphenol, dibutylhydroxy toluene, and phenothiadine. The proportion of a polymerization inhibitor is preferably from 0.01 to 0.1 percent by mass.

These may be used alone or in combination of two or more thereof.

Viscosity

The viscosity of the active energy ray curing composition of the present disclosure has no particular limit and it can be adjusted to suit to a particular application and device. For a discharging device that discharges the composition from nozzles, the viscosity thereof is preferably in the range of from 3 to 40 mPa·s, more preferably from 5 to 15 mPa·s, and particularly preferably from 6 to 12 mPa·s in the temperature range of from 20 to 65 degrees C., preferably at 25 degrees C.

The preferable range of the viscosity of the active energy ray curing composition of the present disclosure is preferably satisfied without containing the organic solvent mentioned above.

Viscosity can be measured by a cone plate type rotary viscometer (VISCOMETER TVE-22L, manufactured by TOKI SANGYO CO., LTD.) using a cone rotor (1°34′×R24) at a rate of rotation of 50 rpm with a setting of the temperature of hemathermal circulating water in the range of from 20 to 65 degrees C. The temperature of the circulating water can be controlled with a VISCOMATE VM-150III.

Active Energy Rays

The active energy rays for use in curing the active energy ray curing composition of the present disclosure is not particularly limited as long as it can apply energy to proceed the polymerization reaction of the polymerizable component in the active energy ray curing composition. Specific examples include, but are not limited to, electron beams, α rays, β rays, γ rays, and X rays, in addition to ultraviolet rays. In an embodiment in which a particularly high energy light source is used, polymerization occurs without a polymerization initiator. In addition, mercury-free is strongly preferable to protect the environment when ultraviolet is used. Using a GaN-based semiconductor ultraviolet light-emitting device is excellent from industrial and environmental points of view. Furthermore, ultraviolet light-emitting diodes (UV-LED) and ultraviolet laser diodes (UV-LD) are preferable as ultraviolet light source because they have small sizes, long working life, and high efficiency, and enjoy high cost performance.

Method of Manufacturing Active Energy Ray Curing Composition

The active energy ray curing composition of the present disclosure can be prepared by using the compositions mentioned above. The device and the condition for preparation is not particularly limited. One way of preparing the composition is: dispersing the urethane acrylate oligomer (A), the polyfunctional monomer (B), the monofunctional monomer (C), the surfactant (D) having a siloxane bond, and other components such as a coloring material and a dispersant with a dispersing device such as a kitty mill, disk mill, pin mill, and DYNO-MILL to prepare a liquid dispersion containing a pigment; and mixing the liquid dispersion with the urethane acrylate oligomer (A), the polyfunctional monomer (B), the monofunctional monomer (C), a polymerization initiator, and other components such as a polymerization initiator.

Application Field

The application field of the active energy ray curing composition of the present disclosure is not particularly limited. It can be applied to any field where the active energy ray curing composition is used. The composition is selected to suit to a particular application. Examples include, but are not limited to, a resin for use in molding, a paint, an adhesive, an insulant, a releasing agent, a coating material, a sealing material, resists, and optical materials.

The active energy ray curing composition mentioned above can be used as an ink to form two-dimensional texts, images, and designed coating film on various substrates and in addition as a material for fabricating a solid object for forming a three-dimensional object.

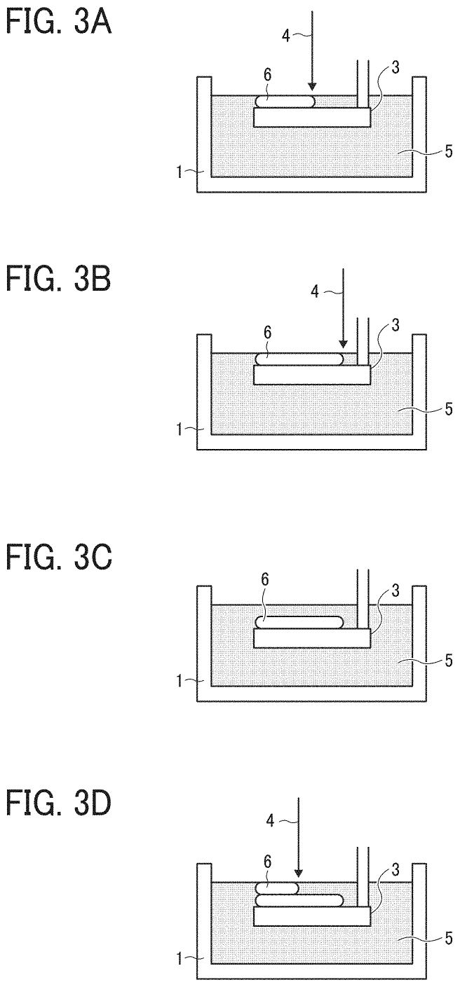

This material for fabricating a solid object is not particularly limited and can be suitably selected to suit to a particular application. The material can be used as a binder for powder particles for use in powder additive manufacturing to conduct solid freeform fabrication by repeating curing and laminating powder layers. Also, it can be used as a solid constituting material (modeling material) or supporting member (supporting material) for use in an additive manufacturing method of stereolithography as illustrated in FIG. 2 and FIGS. 3A to 3D. FIG. 2 is a diagram illustrating a method of fabricating a solid freeform fabrication object by discharging the active energy ray curing composition of the present disclosure to particular regions, exposing the composition on the particular region to active energy rays to cure, and laminating the cured matter by repeating discharging and curing the active energy ray curing composition. FIGS. 3A to 3D are diagrams illustrating a method of forming a solid freeform fabrication object by exposing a pool (accommodating portion) 1 of the active energy ray curing composition 5 of the present disclosure to an active energy ray 4 to form a cured layer 6 having a particular form on a movable stage 3, followed by sequentially laminating the cured layers 6. In FIG. 3A, the pool 1 of the active energy ray curing composition 5 of the present disclosure is exposed to the active energy ray 4. In FIG. 3B, the cured layer 6 having a particular shape is formed on the movable stage 3 owing to the exposure to the active energy ray 4. In FIG. 3C, the movable stage 3 is lowered. In FIG. 3D, another cured layer 6 is sequentially formed on the formed cured layer 6 owing to the exposure to the active energy ray 4.

Solid freeform fabrication objects are fabricated with a solid freeform fabrication device using the active energy ray curing composition of the present disclosure. The solid freeform fabrication device is not particularly limited. For example, it includes an accommodating unit for accommodating the active energy ray curing composition, a supplying device for supplying the active energy ray curing composition, a discharging device for discharging the active energy ray curing composition, and an exposure for exposing the active energy ray curing composition to active energy rays.

Cured matter obtained by curing the active energy ray curing composition of the present disclosure includes a mold-processed product obtained by processing a structure formed of a substrate and the cured matter on the substrate.

The mold-processed product is not particularly limited and can be obtained by, for example, subjecting cured matter or structure having a sheet form or film form to molding process such as hot drawing and punching. This mold-processed product is preferably used for items to be molded after surface decoration. They are gauges or operation panels of products such as vehicles, office machines, electric and electronic machines, and cameras.

In addition, a decorative object formed of a substrate and the surface decorated of the cured matter can be formed by using the active energy ray curing composition of the present disclosure.

The substrate for use in the mold-processed product and decorative object is not particularly limited. It can suitably be selected to suit to a particular application. Specific examples include, but are not limited to, paper, thread, fiber, fabrics, leather, metal, plastic, glass, wood, ceramics, or composite materials thereof. Of these, plastic substrates are preferable in terms of processability.

Active Energy Ray Curing Ink Composition

The active energy ray curing ink composition contains the active energy ray curing composition mentioned above, and other optional components such as a polymerization initiator, a coloring material, and an organic solvent.

The polymerization initiator, coloring material, organic solvent, and other components can be the same as those contained in the active energy ray curing composition mentioned above.

The proportion of the active energy ray curing composition in the active energy ray curing ink composition is not particularly limited and can be suitably determined depending on the proportion of the urethane acrylate oligomer (A), the polyfunctional monomer (B), the monofunctional monomer (C), the surfactant (D) having a siloxane bond in the active energy ray curing ink composition.

The method of preparing the active energy ray curing ink composition is not particularly limited and can be suitably selected to suit to a particular application. One way of preparing is the same as the method of preparing the active energy ray curing composition described above.

Active Energy Ray Curing Inkjet Ink Composition

The active energy ray curing inkjet ink composition of the present disclosure contains the active energy ray curing ink composition mentioned above, and other optional components such as a polymerization initiator, a coloring material, and an organic solvent.

The polymerization initiator, coloring material, organic solvent, and other components in the active energy ray curing inkjet ink composition can be the same as those contained in the active energy ray curing composition and the active energy ray curing ink composition mentioned above.

The proportion of the active energy ray curing ink composition in the active energy ray curing inkjet ink composition is not particularly limited and can be suitably determined depending on the proportion of the active energy ray curing composition mentioned above, the urethane acrylate oligomer (A), the polyfunctional monomer (B), the monofunctional monomer (C), the surfactant (D) having a siloxane bond in the active energy ray curing inkjet ink composition.

The method of preparing the active energy ray curing inkjet ink composition is not particularly limited and can be suitably selected to suit to a particular application. One way of preparing is the same as the method of preparing the active energy ray curing composition described above.

In the present specification, “active energy ray curing composition”, “active energy ray curing ink composition”, and “active energy ray curing inkjet ink composition” are also referred to as “active energy ray curing compositions”.

The active energy ray curing inkjet ink composition can be accommodated in a composition container, which is described later. Using the active energy ray curing inkjet ink, an inkjet printing apparatus as an image forming apparatus can form images by discharging the active energy ray curing inkjet ink composition to an image substrate such as paper.

Composition Container

The composition container of the present disclosure contains at least one of the active energy ray curing composition, the active energy ray curing ink composition, and the active energy ray curing inkjet ink composition.

The composition container can be of any size, any form, and any material. For example, the container can be designed to suit to a particular application. The container is preferably made of a light blocking material that blocks the light or covered with materials such as a light blocking sheet.

The composition container is preferable for the usage described below. If the active energy ray curing composition of the present disclosure is used as ink, i.e., the active energy radiation curing ink composition or active energy radiation curing inkjet ink composition, the composition container containing the ink can be used as an ink cartridge or an ink bottle. This configuration enables users to avoid direct contact with the ink during operations such as conveyance or replacement of the ink, so that the users can keep the fingers and clothes clean. In addition, the ink is prevented from mixing with foreign objects such as dust.

Apparatus for Forming Two-dimensional or Three-dimensional Image and Method of Forming Two-dimensional or Three-dimensional Image

The apparatus for forming a two-dimensional or three-dimensional image of the present disclosure includes an accommodating unit containing either one of the active energy ray curing composition, the active energy ray curing ink composition, or the active energy ray curing inkjet ink composition of the present disclosure, an irradiator for emitting active energy rays, and an optional device such as a discharging device for discharging either one of the active energy ray curing composition, the active energy ray curing ink composition, or the active energy ray curing inkjet ink composition.

The accommodating unit in the apparatus for forming a two-dimensional or three-dimensional image may optionally include the composition container mentioned above.

The method of forming a two-dimensional or three-dimensional image of the present disclosure includes irradiating either one of the active energy ray curing composition, the active energy ray curing ink composition, or the active energy ray curing inkjet ink composition of the present disclosure, and optionally discharging either one of the active energy ray curing composition, the active energy ray curing ink composition, or the active energy ray curing inkjet ink composition.

In the method of forming a two-dimensional or three-dimensional image of the present disclosure, images can be formed by emitting active energy rays to the active energy radiation curing composition or heating the active energy radiation curing composition.

In the present specification, “apparatus for forming a two-dimensional or three-dimensional image” is also referred to as “image forming apparatus” and method of forming a two-dimensional or three-dimensional image” is also referred to as “image forming method.

Curing Device and Curing Process

The irradiator irradiates either one of the active energy ray curing composition, the active energy ray curing ink composition, and the active energy ray curing inkjet ink composition with active energy rays to cure one of the compositions.

The irradiator irradiates, for example, liquid film formed on a stage with active energy rays to cure, the liquid film being formed of either one of the active energy ray curing composition, the active energy ray curing ink composition, and the active energy ray curing inkjet ink composition with active energy rays.

In the irradiating process, either one of the active energy ray curing composition, the active energy ray curing ink composition, and the active energy ray curing composition of the present disclosure cures upon irradiation of active energy rays.

Discharging Device and Discharging Process

The irradiator irradiates either one of the active energy ray curing composition, the active energy ray curing ink composition, and the active energy ray curing composition with active energy rays to cure one of the compositions.

In the discharging process, either one of the active energy ray curing composition, the active energy ray curing ink composition, and the active energy ray curing composition of the present disclosure is discharged.

The method of discharging using the discharging device is not particularly limited as long as it employs inkjetting and can be suitably selected to suit to a particular application. The method includes continuous spraying and on-demand discharging.

The on demand discharging is not particularly limited and can be selected to suit to a suitable application. It includes a piezo method, thermal method, and electrostatic method.

A method of fabricating a solid freeform fabrication object and an apparatus for fabricating a solid freeform fabrication object are described below when the active energy ray curing composition of the present disclosure is used as a material for fabricating a solid freeform fabrication object. However, applications of the active energy ray curing composition of the present disclosure are not limited to these embodiments.

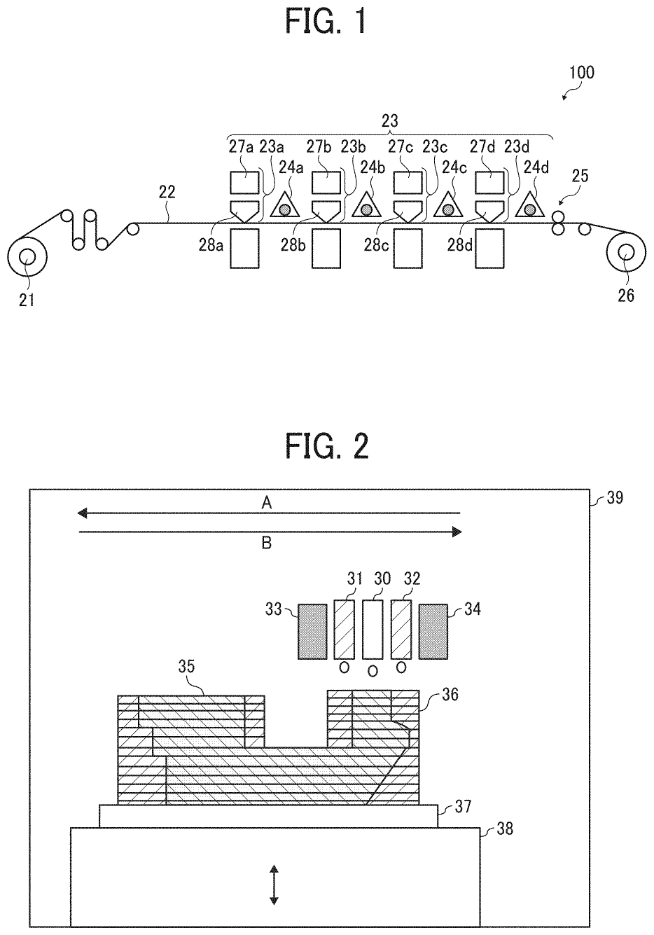

FIG. 1 is a diagram illustrating an image forming apparatus 100 including the discharging device mentioned above. Printing units 23a, 23b, 23c, and 23d respectively have ink cartridges 27a, 27b, 27c, and 27d as composition containers and discharging heads 28a, 28b, 28c, and 28d for yellow, magenta, cyan, and black active energy ray curing ink compositions. The units discharge the active energy ray curing ink compositions onto a substrate (or printing medium) 22 fed from a supplying roll 21. Thereafter, irradiators (or light sources) 24a, 24b, 24c, and 24d emit active energy rays to the inks to cure them, thereby forming a color image. Thereafter, the recording medium 22 is conveyed to a processing unit 25 and a printed matter reeling roll 26.

Each of the printing units 23a, 23b, 23c, and 23d may include a heating assembly for liquidizing the active energy ray curing ink compositions of corresponding colors at the ink discharging units. In addition, a mechanism may be optionally disposed which cools down the printing medium to an ambient temperature in a contact or non-contact manner.

The inkjet printing method includes: a serial method including discharging the active energy ray curing ink composition of each color onto a printing medium that continually moves in accordance with the width of a discharging head while moving the head; and a line method including discharging the active energy ray curing ink composition of each color from a discharging head held at a particular position onto a printing medium, which continuously moves. The image forming apparatus may have a simplex printing configuration capable of printing an image on one side of a printing medium or a duplex printing configuration capable of printing an image on both sides thereof.

The material of the printing medium is not limited to that for general printing media and can be suitably selected to suit to a particular application.

Specific examples include, but are not limited to, paper, film, ceramics, glass, metal, corrugated boards, building materials such as wall paper and flooring material, concrete, cloth for apparel such as T-shirts, textile, leather, and their composite materials.

There is no specific limit to the form of the printing medium. One of the printing media is a sheet-like form.

The size and the structure of the printing medium is not particularly limited and can be suitably selected to suit to a particular application.

The terms of image forming, recording, and printing in the present disclosure represent the same meaning.

Also, recording media, media, and print substrates in the present disclosure have the same meaning unless otherwise specified.

In addition, the light source 24d may expose the image to active energy rays after an image of multiple colors is printed with no or faint active energy rays from the light sources 24a, 24b, and 24c. This configuration saves energy and cost.

The printed matter having images printed with the active energy ray curing ink composition of the present disclosure includes items having printed text or images on a plain surface of a medium such as conventional paper and resin film, items having printed text or images on a printing surface having a rough surface, and items having printed text or images on a printing surface made of various materials such as metal or ceramic. The printed matter can make a partially solid feeling image formed of two-dimensional image portions and three-dimensional image portions or a solid object by laminating two dimensional images.

FIG. 2 is a schematic diagram illustrating another example of the image forming apparatus (apparatus for fabricating a three-dimensional image) related to the present disclosure. An image forming apparatus 39 illustrated in FIG. 2 stacks layers by: discharging a first active energy ray curing composition from a discharging head unit 30 for a fabrication part and a second active energy ray curing composition composed of different ingredients from those of the first active energy ray curing composition from discharging head units 31 and 32 for a support part by using a head unit having inkjet heads disposed movable in the directions indicated by the arrows A and B; curing each composition with active energy rays irradiators 33 and 34 disposed adjacent to the discharging head units 31 and 32 respectively; and repeating the discharging and the curing. More specifically, the discharging head units 31 and 32 for a support part discharge the second active energy curing composition onto a substrate 37 for supporting a fabrication object. The second active energy curing composition is solidified at exposure to active energy rays, thereby forming a first support layer having a hollow space (pool) for fabrication. The discharging head unit 30 for fabrication discharges the first active energy curing composition onto the hollow space followed by exposure to active energy rays for solidification, which forms a first fabrication layer. This operation is repeated multiple times in accordance with the desired number of lamination while moving the stage 38 up and down in the vertical direction to laminate the support layer and the fabrication layer. A solid freeform fabrication object 35 is thus created. Thereafter, a laminated support 36 is removed.

Although only one discharging head unit 30 for fabrication is illustrated in FIG. 2, the apparatus can have two or more units 30.

Cured Matter

The cured matter of the present disclosure is formed or produced by exposing at least one of the active energy ray curing composition, the active energy ray curing ink composition, and the active energy ray curing inkjet ink composition of the present disclosure to active energy rays.

The active energy ray curing composition can be the same as the active energy ray curing composition mentioned above, the active energy ray curing ink composition can be the same as the active energy ray curing ink composition mentioned above, and the active energy ray curing inkjet ink composition can be the same as the active energy ray curing inkjet ink composition mentioned above.

In the preset specification, the cured matter and the applied film have the same meaning.

Decorative Object

The decorative object of the present disclosure has a substrate and a surface decoration made of the cured matter mentioned above on the substrate.

The substrate is not particularly limited and can be suitably selected to suit to a particular application. It includes the substrate for the molded product and decorative object mentioned in Application Field above.

The form of the decorative object is not particularly limited and can be suitably selected to suit to a particular application. It is preferably a cylindrical form.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but is not limited thereto.

### Examples 1 to 25 and Comparative Examples 1 to 16

Preparation of Active Energy Ray Curing Composition

The materials and proportion (percent by mass) shown in Tables 1 to 8 were mixed with a three-one motor (manufactured by SHINTO Scientific Co., Ltd.) to prepare active energy ray curing compositions of each of Examples and Comparative Example.

Evaluation on Continuous Discharging Stability

The active energy ray curing compositions of Examples 1 to 25 and Comparative Examples 1 to 16 were placed in an inkjet discharging device (manufactured by Ricoh Co., Ltd.) including an inkjet head (GEN5, manufactured by Ricoh Co., Ltd.), followed by continuously discharging with the discharging device for 30 minutes. Thereafter, the discharging of the nozzles in the head was observed with a camera (ARTCAM-036MI, manufactured by ARTRAY CO., LTD.). The continuous discharging stability was evaluated according to the following evaluation criteria. The results are shown in Tables 1 to 8.

Evaluation Criteria for Continuous Discharging Stability

A: Discharged from all nozzles
B: Not discharged (less than 30 nozzles)
C: Not discharged (30 or more nozzles)

Preparation of Cured Matter

The active energy ray curing compositions of Examples 1 to 25 and Comparative Examples 1 to 16 were placed in an inkjet printer (manufactured by Ricoh Co., Ltd.) including an inkjet head (GEN5, manufactured by Ricoh Co., Ltd.) and an light emitting diode (LED) lamp (peak wavelength of 395 nm, 3,000 mJ/cm², manufactured by USHIO INC.). A liquid film having an average thickness of 10 μm was formed on a glass substrate (S9213, manufactured by Matsunami Glass Ind., Ltd.) using the inkjet printer and solidified with the LED lamp of USHIO INC.

Evaluation on Attachability

The cured matter obtained by curing the active energy ray curing compositions of Examples 1 to 25 and Comparative Examples 1 to 16 was evaluated on the attachability in the following manner.

Ethanol at 99.5 percent manufactured by Kanto Chemical Co., Inc. was diluted with deionized water to prepare an aqueous solution of ethanol at 50 percent. The 50 percent ethanol was added to dip the entire of the obtained cured matter followed by resting at room temperature for one hour. The attachability of each cured matter after resting was evaluated according to the following evaluation criteria. The results are shown in Tables 1 to 8.

Evaluation Criteria on Attachability

A: No peeling of cured matter after dipping
C: Cured matter peeled after dipping

Evaluation on Strength of Applied Film

The cured matter obtained by curing the active energy ray curing compositions of Examples 1 to 25 and Comparative Examples 1 to 16 was evaluated on the strength of applied film in the following manner.

Ethanol at 99.5 percent manufactured by Kanto Chemical Co., Inc. was diluted with deionized water to prepare an aqueous solution of ethanol at 50 percent. The 50 percent ethanol was added to dip the entire of the obtained cured matter followed by resting at room temperature for one hour. The liquid droplets attached to the surface of an image were wiped off. The applied film was evaluated on the strength according to the pencil hardness test, JIS K5600-5-4 format (scratch hardness by pencil method). The results are shown in Tables 1 to 8.

Evaluation Criteria of Strength of Applied Film

### S: 6H to 9H

### A: 3H to 5H

### B: F to 2H

### C: 9B to HB

Evaluation on Resistance to Alcohol

The cured matter obtained by curing the active energy ray curing compositions of Examples 1 to 25 and Comparative Examples 1 to 16 was evaluated on the attachability in the following manner.

The surface of the cured matter was rubbed with white cloth cotton (trade name: Kanakin No. 3) attached to the test in accordance with JIS L 0803 format soaked in 99.5 percent ethanol (manufactured by Kanto Chemical Co., Inc.) back and forth five times at room temperature (25 degrees C.). How the surface of the cured matter changed was visually checked and evaluated according to the following evaluation criteria. The results are shown in Tables 1 to 8.

Evaluation Criteria on Resistance to Alcohol

A: No change
B: Surface slightly whitened
C: Surface whitened

TABLE 1

| | | Number | Glass | Mass | | | | | |
|---|---|---|---|---|---|---|---|---|---|
| | | of | transition | average | | | | | |
| | | functional | temperature | molecular | Example | | | | |
| | | groups | (degrees C) | mass | 1 | 2 | 3 | 4 | 5 |
| Oligomer | KRM8667 | 3 | 85 | 2000 | 5 | 15 | 5 | 5 | 5 |
| | CN8885NS | 9 | 36 | 1800 | — | — | — | — | — |
| | EVECRYL220 | 6 | 48 | 1000 | — | — | — | — | — |
| | EVECRYL4666 | 4 | 83 | 1100 | — | — | — | — | — |
| | EVECRYL294/25HD | 3 | 60 | 1500 | — | — | — | — | — |
| | UV-7510B | 3 | 17 | 3500 | — | — | — | — | — |
| | EVECRYL210 | 2 | −19 | 1500 | — | — | — | — | — |
| | EVECRYL4265 | 3 | 73 | 650 | — | — | — | — | — |
| | CN981NS | 2 | 22 | 2000 | — | — | — | — | — |
| | CN968NS | 6 | 145 | 2500 | — | — | — | — | — |
| | CN131BNS | 1 | 10 | 1000 | — | — | — | — | — |
| Total (oligomer) | | | | | 5 | 15 | 5 | 5 | 5 |
| Monofunctional | THFA having heterocyclic structure | | | | 10 | 10 | 10 | 10 | 10 |
| monomer | CTFA having heterocyclic structure | | | | 34.8 | 29.8 | 34.8 | 34.8 | 34.8 |
| | ACMO having heterocyclic structure | | | | — | — | — | — | — |
| | PEA having no heterocyclic structure | | | | — | — | — | — | — |
| | IBXA having no heterocyclic structure | | | | — | — | — | — | — |
| Total (mono-functional monomer) | | | | | 44.8 | 39.8 | 40 | 44.8 | 44.8 |
| Polyfunctional | DGPDA | 2 | — | — | 10 | 13 | 10 | — | — |
| monomer | TMPTA | 3 | — | — | 30 | 22 | 30 | 40 | 40 |
| | PETA | 4 | — | — | — | — | — | — | — |

| Total (polyfunctional monomer having three or more functional groups) | | 30 | 22 | 30 | 40 | 40 |
|---|---|---|---|---|---|---|
| Polymerization | TPO | 7 | 7 | 7 | 7 | 7 |
| initiator | Irg819 | 3 | 3 | 3 | 3 | 3 |
| Polymerization | BHT | 0.1 | 0.1 | 0.1 | 0.1 | 0.1 |
| inhibitor | | | | | | |
| Surfactant | Rad2300 having siloxane bond with 4 or less functional groups | 0.1 | 0.1 | — | 0.1 | — |
| | Rad2500 having siloxane bond with 4 or less functional groups | — | — | 0.1 | — | 0.1 |
| | Rad2100 having siloxane bond with 5 or more functional groups | — | — | — | — | — |
| | WET270 having siloxane bond with 5 or more functional groups | — | — | — | — | — |
| | WET500 having no siloxane bond | — | — | — | — | — |
| Total | | 100 | 100 | 100 | 100 | 100 |
| Evaluation | Attachability (after soaked in ethanol) | A | A | A | A | A |
| | Pencil hardness (after soaked in ethanol) | S | A | S | A | A |
| | Resistance to alcohol | A | A | A | A | A |
| | Continuous discharging stability | A | B | A | A | A |

TABLE 2

| | | Number | Glass | Mass | | | | | |
|---|---|---|---|---|---|---|---|---|---|
| | | of | transition | average | | | | | |
| | | functional | temperature | molecular | Example | | | | |
| | | groups | (degrees C) | mass | 6 | 7 | 8 | 9 | 10 |
| Oligomer | KRM8667 | 3 | 85 | 2000 | — | — | — | — | — |
| | CN8885NS | 9 | 36 | 1800 | 5 | — | — | — | — |
| | EVECRYL220 | 6 | 48 | 1000 | — | 5 | — | — | — |
| | EVECRYL4666 | 4 | 83 | 1100 | — | — | 5 | — | — |
| | EVECRYL294/25HD | 3 | 60 | 1500 | — | — | — | 5 | — |
| | UV-7510B | 3 | 17 | 3500 | — | — | — | — | 5 |
| | EVECRYL210 | 2 | −19 | 1500 | — | — | — | — | — |
| | EVECRYL4265 | 3 | 73 | 650 | — | — | — | — | — |
| | CN981NS | 2 | 22 | 2000 | — | — | — | — | — |
| | CN968NS | 6 | 145 | 2500 | — | — | — | — | — |
| | CN131BNS | 1 | 10 | 1000 | — | — | — | — | — |
| Total (oligomer) | | | | | 5 | 5 | 5 | 5 | 5 |
| Monofunctional | THFA having heterocyclic structure | | | | 10 | 10 | 10 | 10 | 10 |
| monomer | CTFA having heterocyclic structure | | | | 34.8 | 34.8 | 34.8 | 34.8 | 34.8 |
| | ACMO having heterocyclic structure | | | | — | — | — | — | — |
| | PEA having no heterocyclic structure | | | | — | — | — | — | — |
| | IBXA having no heterocyclic structure | | | | — | — | — | — | — |
| Total (mono-functional monomer) | | | | | 44.8 | 44.8 | 44.8 | 44.8 | 44.8 |
| Polyfunctional | DGPDA | 2 | — | — | — | — | — | — | — |
| monomer | TMPTA | 3 | — | — | 40 | 40 | 40 | 40 | 40 |
| | PETA | 4 | — | — | — | — | — | — | — |

| Total (polyfunctional monomer having three or more functional groups) | | 40 | 40 | 40 | 40 | 40 |
|---|---|---|---|---|---|---|
| Polymerization | TPO | 7 | 7 | 7 | 7 | 7 |
| initiator | Irg819 | 3 | 3 | 3 | 3 | 3 |
| Polymerization | BHT | 0.1 | 0.1 | 0.1 | 0.1 | 0.1 |
| inhibitor | | | | | | |
| Surfactant | Rad2300 having siloxane bond with 4 or less functional groups | 0.1 | 0.1 | 0.1 | 0.1 | 0.1 |
| | Rad2500 having siloxane bond with 4 or less functional groups | — | — | — | — | — |
| | Rad2100 having siloxane bond with 5 or more functional groups | — | — | — | — | — |
| | WET270 having siloxane bond with 5 or more functional groups | — | — | — | — | — |
| | WET500 having no siloxane bond | — | — | — | — | — |
| Total | | 100 | 100 | 100 | 100 | 100 |
| Evaluation | Attachability (after soaked in ethanol) | A | A | A | A | A |
| | Pencil hardness (after soaked in ethanol) | A | A | A | A | A |
| | Resistance to alcohol | A | A | A | A | A |
| | Continuous discharging stability | A | A | A | A | A |

TABLE 3

| | | Number | Glass | Mass | | | | | |
|---|---|---|---|---|---|---|---|---|---|
| | | of | transition | average | | | | | |
| | | functional | temperature | molecular | Example | | | | |
| | | groups | (degrees C) | mass | 11 | 12 | 13 | 14 | 15 |
| Oligomer | KRM8667 | 3 | 85 | 2000 | 5 | 5 | 5 | — | 5 |
| | CN8885NS | 9 | 36 | 1800 | — | — | — | — | — |
| | EVECRYL220 | 6 | 48 | 1000 | — | — | — | 5 | — |
| | EVECRYL4666 | 4 | 83 | 1100 | — | — | — | — | — |
| | EVECRYL294/25HD | 3 | 60 | 1500 | — | — | — | — | — |
| | UV-7510B | 3 | 17 | 3500 | — | — | — | — | — |
| | EVECRYL210 | 2 | −19 | 1500 | — | — | — | — | — |
| | EVECRYL4265 | 3 | 73 | 650 | — | — | — | — | — |
| | CN981NS | 2 | 22 | 2000 | — | — | — | — | — |
| | CN968NS | 6 | 145 | 2500 | — | — | — | — | — |
| | CN131BNS | 1 | 10 | 1000 | — | — | — | — | — |
| Total (oligomer) | | | | | 5 | 5 | 5 | 5 | 5 |
| Monofunctional | THFA having heterocyclic structure | | | | - | 10 | 10 | 18 | 10 |
| monomer | CTFA having heterocyclic structure | | | | 34.8 | 34.8 | 34.8 | 34.8 | 29.8 |
| | ACMO having heterocyclic structure | | | | 10 | — | — | — | — |
| | PEA having no heterocyclic structure | | | | — | — | — | — | — |
| | IBXA having no heterocyclic structure | | | | — | — | — | — | — |
| Total (mono-functional monomer) | | | | | 44.8 | 44.8 | 44.8 | 52.8 | 39.8 |
| Polyfunctional | DGPDA | 2 | — | — | — | — | — | — | — |
| monomer | TMPTA | 3 | — | — | 40 | 40 | 40 | — | 45 |
| | PETA | 4 | — | — | — | — | — | 22 | — |

| Total (polyfunctional monomer having three or more functional groups) | | 40 | 40 | 40 | 22 | 45 |
|---|---|---|---|---|---|---|
| Polymerization | TPO | 7 | 7 | 7 | 7 | 7 |
| initiator | Irg819 | 3 | 3 | 3 | 3 | 3 |
| Polymerization | BHT | 0.1 | 0.1 | 0.1 | 0.1 | 0.1 |
| inhibitor | | | | | | |
| Surfactant | Rad2300 having siloxane bond with 4 or less functional groups | 0.1 | — | — | 0.1 | 0.1 |
| | Rad2500 having siloxane bond with 4 or less functional groups | — | — | — | — | — |
| | Rad2100 having siloxane bond with 5 or more functional groups | — | 0.1 | — | — | — |
| | WET270 having siloxane bond with 5 or more functional groups | — | — | 0.1 | — | — |
| | WET500 having no siloxane bond | — | — | — | — | — |
| Total | | 100 | 100 | 100 | 100 | 100 |
| Evaluation | Attachability (after soaked in ethanol) | A | A | A | A | A |
| | Pencil hardness (after soaked in ethanol) | A | A | A | A | A |
| | Resistance to alcohol | A | B | B | A | A |
| | Continuous discharging stability | A | A | A | A | A |

TABLE 4

| | | Number | Glass | Mass | | | | | |
|---|---|---|---|---|---|---|---|---|---|
| | | of | transition | average | | | | | |
| | | functional | temperature | molecular | Example | | | | |
| | | groups | (degrees C) | mass | 16 | 17 | 18 | 19 | 20 |
| Oligomer | KRM8667 | 3 | 85 | 2000 | 5 | 10 | 2 | 11 | 5 |
| | CN8885NS | 9 | 36 | 1800 | — | — | — | — | — |
| | EVECRYL220 | 6 | 48 | 1000 | — | — | — | — | — |
| | EVECRYL4666 | 4 | 83 | 1100 | — | — | — | — | — |
| | EVECRYL294/25HD | 3 | 60 | 1500 | — | — | — | — | — |
| | UV-7510B | 3 | 17 | 3500 | — | — | — | — | — |
| | EVECRYL210 | 2 | −19 | 1500 | — | — | — | — | — |
| | EVECRYL4265 | 3 | 73 | 650 | — | — | — | — | — |
| | CN981NS | 2 | 22 | 2000 | — | — | — | — | — |
| | CN968NS | 6 | 145 | 2500 | — | — | — | — | — |
| | CN131BNS | 1 | 10 | 1000 | — | — | — | — | — |
| Total (oligomer) | | | | | 5 | 10 | 2 | 11 | 5 |
| Monofunctional | THFA having heterocyclic structure | | | | 10 | 10 | 10 | 10 | — |
| monomer | CTFA having heterocyclic structure | | | | 28.8 | 29.8 | 37.8 | 28.8 | — |
| | ACMO having heterocyclic structure | | | | — | — | — | — | — |
| | PEA having no heterocyclic structure | | | | — | — | — | — | — |
| | IBXA having no heterocyclic structure | | | | — | — | — | — | 44.8 |
| Total (mono-functional monomer) | | | | | 38.8 | 39.8 | 47.8 | 38.8 | 44.8 |
| Polyfunctional | DGPDA | 2 | — | — | — | — | — | — | 10 |
| monomer | TMPTA | 3 | — | — | 46 | 40 | 40 | 40 | 30 |
| | PETA | 4 | — | — | — | — | — | — | — |

| Total (polyfunctional monomer having three or more functional groups) | | 46 | 40 | 40 | 40 | 30 |
|---|---|---|---|---|---|---|
| Polymerization | TPO | 7 | 7 | 7 | 7 | 7 |
| initiator | Irg819 | 3 | 3 | 3 | 3 | 3 |
| Polymerization | BHT | 0.1 | 0.1 | 0.1 | 0.1 | 0.1 |
| inhibitor | | | | | | |
| Surfactant | Rad2300 having siloxane bond with 4 or less functional groups | 0.1 | 0.1 | 0.1 | 0.1 | 0.1 |
| | Rad2500 having siloxane bond with 4 or less functional groups | — | — | — | — | — |
| | Rad2100 having siloxane bond with 5 or more functional groups | — | — | — | — | — |
| | WET270 having siloxane bond with 5 or more functional groups | — | — | — | — | — |
| | WET500 having no siloxane bond | — | — | — | — | — |
| Total | | 100 | 100 | 100 | 100 | 100 |
| Evaluation | Attachability (after soaked in ethanol) | A | A | A | A | A |
| | Pencil hardness (after soaked in ethanol) | A | A | B | B | B |
| | Resistance to alcohol | A | B | B | B | A |
| | Continuous discharging stability | B | B | A | B | A |

TABLE 5

| | | Number | Glass | Mass | | | | | |
|---|---|---|---|---|---|---|---|---|---|
| | | of | transition | average | | | | | |
| | | functional | temperature | molecular | Example | | | | |
| | | groups | (degrees C) | mass | 21 | 22 | 23 | 24 | 25 |
| Oligomer | KRM8667 | 3 | 85 | 2000 | 5 | 5 | 5 | 5 | 5 |
| | CN8885NS | 9 | 36 | 1800 | — | — | — | — | — |
| | EVECRYL220 | 6 | 48 | 1000 | — | — | — | — | — |
| | EVECRYL4666 | 4 | 83 | 1100 | — | — | — | — | — |
| | EVECRYL294/25HD | 3 | 60 | 1500 | — | — | — | — | — |
| | UV-7510B | 3 | 17 | 3500 | — | — | — | — | — |
| | EVECRYL210 | 2 | −19 | 1500 | — | — | — | — | — |
| | EVECRYL4265 | 3 | 73 | 650 | — | — | — | — | — |
| | CN981NS | 2 | 22 | 2000 | — | — | — | — | — |
| | CN968NS | 6 | 145 | 2500 | — | — | — | — | — |
| | CN131BNS | 1 | 10 | 1000 | — | — | — | — | — |
| Total (oligomer) | | | | | 5 | 5 | 5 | 5 | 5 |
| Monofunctional | THFA having heterocyclic structure | | | | 10 | — | 10 | 16 | 10 |
| monomer | CTFA having heterocyclic structure | | | | — | — | — | 36.8 | 14.8 |
| | ACMO having heterocyclic structure | | | | — | — | — | — | — |
| | PEA having no heterocyclic structure | | | | — | 44.8 | 34.8 | — | — |
| | IBXA having no heterocyclic structure | | | | 34.8 | — | — | — | — |
| Total (mono-functional monomer) | | | | | 44.8 | 44.8 | 44.8 | 52.8 | 24.8 |
| Polyfunctional | DGPDA | 2 | — | — | 10 | 10 | 10 | 10 | — |
| monomer | TMPTA | 3 | — | — | 30 | 30 | 30 | 22 | 60 |
| | PETA | 4 | — | — | — | — | — | — | — |

| Total (polyfunctional monomer having three or more functional groups) | | 30 | 30 | 30 | 22 | 60 |
|---|---|---|---|---|---|---|
| Polymerization | TPO | 7 | 7 | 7 | 7 | 7 |
| initiator | Irg819 | 3 | 3 | 3 | 3 | 3 |
| Polymerization | BHT | 0.1 | 0.1 | 0.1 | 0.1 | 0.1 |
| inhibitor | | | | | | |
| Surfactant | Rad2300 having siloxane bond with 4 or less functional groups | 0.1 | 0.1 | 0.1 | 0.1 | 0.1 |
| | Rad2500 having siloxane bond with 4 or less functional groups | — | — | — | — | — |
| | Rad2100 having siloxane bond with 5 or more functional groups | — | — | — | — | — |
| | WET270 having siloxane bond with 5 or more functional groups | — | — | — | — | — |
| | WET500 having no siloxane bond | — | — | — | — | — |
| Total | | 100 | 100 | 100 | 100 | 100 |
| Evaluation | Attachability (after soaked in ethanol) | A | A | A | A | A |
| | Pencil hardness (after soaked in ethanol) | B | B | B | B | A |
| | Resistance to alcohol | A | A | A | A | A |
| | Continuous discharging stability | A | A | A | A | B |

TABLE 6

| | | Number | Glass | Mass | | | | | |
|---|---|---|---|---|---|---|---|---|---|
| | | of | transition | average | | | | | |
| | | functional | temperature | molecular | Comparative Example | | | | |
| | | groups | (degrees C) | mass | 1 | 2 | 3 | 4 | 5 |
| Oligomer | KRM8667 | 3 | 85 | 2000 | — | — | — | — | — |
| | CN8885NS | 9 | 36 | 1800 | — | — | — | — | — |
| | EVECRYL220 | 6 | 48 | 1000 | — | — | — | — | — |
| | EVECRYL4666 | 4 | 83 | 1100 | — | — | — | — | — |
| | EVECRYL294/25HD | 3 | 60 | 1500 | — | — | — | — | — |
| | UV-7510B | 3 | 17 | 3500 | — | — | — | — | — |
| | EVECRYL210 | 2 | −19 | 1500 | 5 | — | — | — | — |
| | EVECRYL4265 | 3 | 73 | 650 | — | 5 | — | — | — |
| | CN981NS | 2 | 22 | 2000 | — | — | — | — | — |
| | CN968NS | 6 | 145 | 2500 | — | — | 5 | — | — |
| | CN131BNS | 1 | 10 | 1000 | — | — | — | 5 | — |
| Total (oligomer) | | | | | 5 | 5 | 5 | 5 | 0 |
| Monofunctional | THFA having heterocyclic structure | | | | 10 | 10 | 10 | 10 | 15 |
| monomer | CTFA having heterocyclic structure | | | | 34.8 | 34.8 | 34.8 | 34.8 | 34.8 |
| | ACMO having heterocyclic structure | | | | — | — | — | — | — |
| | PEA having no heterocyclic structure | | | | — | — | — | — | — |
| | IBXA having no heterocyclic structure | | | | — | — | — | — | — |
| Total (mono-functional monomer) | | | | | 44.8 | 44.8 | 44.8 | 44.8 | 49.8 |
| Polyfunctional | DGPDA | 2 | — | — | 10 | 10 | — | — | — |
| monomer | TMPTA | 3 | — | — | 30 | 30 | 40 | 40 | 40 |
| | PETA | 4 | — | — | — | — | — | — | — |

| Total (polyfunctional monomer having three or more functional groups) | | 30 | 30 | 40 | 40 | 40 |
|---|---|---|---|---|---|---|
| Polymerization | TPO | 7 | 7 | 7 | 7 | 7 |
| initiator | Irg819 | 3 | 3 | 3 | 3 | 3 |
| Polymerization | BHT | 0.1 | 0.1 | 0.1 | 0.1 | 0.1 |
| inhibitor | | | | | | |
| Surfactant | Rad2300 having siloxane bond with 4 or less functional groups | 0.1 | 0.1 | 0.1 | — | — |
| | Rad2500 having siloxane bond with 4 or less functional groups | — | — | — | — | — |
| | Rad2100 having siloxane bond with 5 or more functional groups | — | — | — | 0.1 | — |
| | WET270 having siloxane bond with 5 or more functional groups | — | — | — | — | 0.1 |
| | WET500 having no siloxane bond | — | — | — | — | — |
| Total | | 100 | 100 | 100 | 100 | 100 |
| Evaluation | Attachability (after soaked in ethanol) | A | A | A | A | C |
| | Pencil hardness (after soaked in ethanol) | x | C | C | C | C |
| | Resistance to alcohol | x | B | A | A | B |
| | Continuous discharging stability | A | A | A | A | A |

TABLE 7

| | | Number | Glass | Mass | | | | | |
|---|---|---|---|---|---|---|---|---|---|
| | | of | transition | average | | | | | |
| | | functional | temperature | molecular | Comparative Example | | | | |
| | | groups | (degrees C) | mass | 6 | 7 | 8 | 9 | 10 |
| Oligomer | KRM8667 | 3 | 85 | 2000 | 5 | 5 | 5 | 5 | 5 |
| | CN8885NS | 9 | 36 | 1800 | — | — | — | — | — |
| | EVECRYL220 | 6 | 48 | 1000 | — | — | — | — | — |
| | EVECRYL4666 | 4 | 83 | 1100 | — | — | — | — | — |
| | EVECRYL294/25HD | 3 | 60 | 1500 | — | — | — | — | — |
| | UV-7510B | 3 | 17 | 3500 | — | — | — | — | — |
| | EVECRYL210 | 2 | −19 | 1500 | — | — | — | — | — |
| | EVECRYL4265 | 3 | 73 | 650 | — | — | — | — | — |
| | CN981NS | 2 | 22 | 2000 | — | — | — | — | — |
| | CN968NS | 6 | 145 | 2500 | — | — | — | — | — |
| | CN131BNS | 1 | 10 | 1000 | — | — | — | — | — |
| Total (oligomer) | | | | | 5 | 5 | 5 | 5 | 5 |
| Monofunctional | THFA having heterocyclic structure | | | | 10 | 10 | 10 | 10 | 10 |
| monomer | CTFA having heterocyclic structure | | | | 53.8 | 43.8 | 34.8 | 34.8 | 34.9 |
| | ACMO having heterocyclic structure | | | | — | — | — | — | — |
| | PEA having no heterocyclic structure | | | | — | — | — | — | — |
| | IBXA having no heterocyclic structure | | | | — | — | — | — | — |
| Total (mono-functional monomer) | | | | | 63.8 | 53.8 | 44.8 | 44.8 | 44.9 |
| Polyfunctional | DGPDA | 2 | — | — | — | 10 | 10 | 40 | 10 |
| monomer | TMPTA | 3 | — | — | 21 | 21 | 30 | — | 30 |
| | PETA | 4 | — | — | — | — | — | — | — |

| Total (polyfunctional monomer having three or more functional groups) | | 21 | 21 | 30 | 0 | 30 |
|---|---|---|---|---|---|---|
| Polymerization | TPO | 7 | 7 | 7 | 7 | 7 |
| initiator | Irg819 | 3 | 3 | 3 | 3 | 3 |
| Polymerization | BHT | 0.1 | 0.1 | 0.1 | 0.1 | 0.1 |
| inhibitor | | | | | | |
| Surfactant | Rad2300 having siloxane bond with 4 or less functional groups | 0.1 | 0.1 | — | — | — |
| | Rad2500 having siloxane bond with 4 or less functional groups | — | — | — | — | — |
| | Rad2100 having siloxane bond with 5 or more functional groups | — | — | — | — | — |
| | WET270 having siloxane bond with 5 or more functional groups | — | — | — | — | — |
| | WET500 having no siloxane bond | — | — | 0.1 | 0.1 | — |
| Total | | 100 | 100 | 100 | 100 | 100 |
| Evaluation | Attachability (after soaked in ethanol) | A | A | A | A | A |
| | Pencil hardness (after soaked in ethanol) | x | C | S | x | S |
| | Resistance to alcohol | A | A | C | C | C |
| | Continuous discharging stability | A | A | A | A | A |

TABLE 8

| | | Number | Glass | Mass | | | | | | |
|---|---|---|---|---|---|---|---|---|---|---|
| | | of | transition | average | | | | | | |
| | | functional | temperature | molecular | Comparative Example | | | | | |
| | | groups | (degrees C) | mass | 11 | 12 | 13 | 14 | 15 | 16 |
| Oligomer | KRM8667 | 3 | 85 | 2000 | 5 | 5 | 5 | — | — | 5 |
| | CN8885NS | 9 | 36 | 1800 | — | — | — | — | — | — |
| | EVECRYL220 | 6 | 48 | 1000 | — | — | — | — | — | — |
| | EVECRYL4666 | 4 | 83 | 1100 | — | — | — | — | — | — |
| | EVECRYL294/25HD | 3 | 60 | 1500 | — | — | — | — | — | — |
| | UV-7510B | 3 | 17 | 3500 | — | — | — | — | — | — |
| | EVECRYL210 | 2 | −19 | 1500 | — | — | — | — | — | — |
| | EVECRYL4265 | 3 | 73 | 650 | — | — | — | — | — | — |
| | CN981NS | 2 | 22 | 2000 | — | — | — | — | 5 | — |
| | CN968NS | 6 | 145 | 2500 | — | — | — | — | — | — |
| | CN131BNS | 1 | 10 | 1000 | — | — | — | — | — | — |
| Total (oligomer) | | | | | 5 | 5 | 5 | 0 | 5 | 5 |
| Monofunctional | THFA having heterocyclic structure | | | | 6 | 50 | — | 10 | 10 | 6 |
| monomer | CTFA having heterocyclic structure | | | | 8.8 | 34.8 | — | 16.8 | 34.8 | 8.8 |
| | ACMO having heterocyclic structure | | | | — | — | — | — | — | — |
| | PEA having no heterocyclic structure | | | | — | — | — | — | — | — |
| | IBXA having no heterocyclic structure | | | | — | — | — | — | — | — |
| Total (mono-functional monomer) | | | | | 14.8 | 84.8 | 0 | 26.8 | 44.8 | 14.8 |
| Polyfunctional | DGPDA | 2 | — | — | — | — | 50 | — | — | — |
| monomer | TMPTA | 3 | — | — | 70 | — | 34.8 | 40 | 40 | 70 |
| | PETA | 4 | — | — | — | — | — | — | — | — |

| Total (polyfunctional monomer having three or more functional groups) | | 70 | 0 | 34.8 | 40 | 40 | 70 |
|---|---|---|---|---|---|---|---|
| Polymerization | TPO | 7 | 7 | 7 | 7 | 7 | 7 |
| initiator | Irg819 | 3 | 3 | 3 | 3 | 3 | 3 |
| Polymerization | BHT | 0.1 | 0.1 | 0.1 | 0.1 | 0.1 | 0.1 |
| inhibitor | | | | | | | |
| Surfactant | Rad2300 having siloxane bond with 4 or less functional groups | — | — | — | 0.1 | 0.1 | 0.1 |
| | Rad2500 having siloxane bond with 4 or less functional groups | — | — | — | — | — | — |
| | Rad2100 having siloxane bond with 5 or more functional groups | — | 0.1 | — | — | — | — |
| | WET270 having siloxane bond with 5 or more functional groups | — | — | 0.1 | — | — | — |
| | WET500 having no siloxane bond | 0.1 | — | — | — | — | — |
| Total | | 100 | 100 | 100 | 100 | 100 | 100 |
| Evaluation | Attachability (after soaked in ethanol) | x | A | C | C | A | C |
| | Pencil hardness (after soaked in ethanol) | x | C | A | A | C | C |
| | Resistance to alcohol | x | B | B | A | A | A |
| | Continuous discharging stability | x | A | C | A | A | C |

The product names and manufactures of the materials used in Examples 1 to 25 and Comparative Examples 1 to 16 are shown in Tables 9.

TABLE 9

| Classification | Product (trade name) | Manufacturer |
|---|---|---|
| Oligomer | KRM8667 | Manufactured by |
| | | DAICEL-ALLNEX |
| | | LTD. |
| | CN8885NS | Manufactured by |
| | | Sartomer Company |
| | EVECRYL220 | Manufactured by |
| | | DAICEL-ALLNEX |
| | | LTD. |
| | EVECRYL4666 | Manufactured by |
| | | DAICEL-ALLNEX |
| | | LTD. |
| | EBECRYL294/25 | Manufactured by |
| | | DAICEL-ALLNEX |
| | | LTD. |
| | CN981NS | Manufactured by |
| | | Sartomer Company |
| | CN968NS | Manufactured by |
| | | Sartomer Company |
| | CN131BNS | Manufactured by |
| | | Sartomer Company |
| | EVECRYL210 | Manufactured by |
| | | DAICEL-ALLNEX |
| | | LTD. |
| | EVECRYL4265 | Manufactured by |
| | | DAICEL-ALLNEX |
| | | LTD. |
| Monofunctional | VISCOAT #150, tetra- | Manufactured by |
| monomer | hydro furfuryl acrylate | OSAKA ORGANIC |
| | (THFA) | CHEMICAL |
| | | INDUSTRY LTD. |
| | VISCOAT #200, cyclic | Manufactured by |
| | trimethyhlol propane | OSAKA ORGANIC |
| | formal acrylate (CTFA) | CHEMICAL |
| | | INDUSTRY LTD. |
| | ACMO, acryloylmorpholine | Manufactured by KJ |
| | | Resins B.V. |
| | VISCOAT #192, phenoxy- | Manufactured by |
| | ethyl acrylate (PEA) | OSAKA ORGANIC |
| | | CHEMICAL |
| | | INDUSTRY LTD. |
| | IBXA, isobonyl acrylate | Manufactured by |
| | | OSAKA ORGANIC |
| | | CHEMICAL |
| | | INDUSTRY LTD. |
| Polyfunctional | VISCOAT #295, trimethyhlol | Manufactured by |
| monomer | propane acrylate (TMPTA) | OSAKA ORGANIC |
| | | CHEMICAL |
| | | INDUSTRY LTD. |
| | SR508, dipropylene glycol | Manufactured by |
| | diacrylate (DPGDA) | Sartomer Company |
| | SR295, pentaerythritol | Manufactured by |
| | tetraacrylate (PETA) | Sartomer Company |
| Surfactant | TEGO-RAD2300 | Manufactured by |
| | | Evonik Industries AG |
| | TEGO-RAD2500 | Manufactured by |
| | | Evonik Industries AG |
| | TEGO-RAD2100 | Manufactured by |
| | | Evonik Industries AG |
| | TEGO-WET270 | Manufactured by |
| | | Evonik Industries AG |
| | TEGO-WET500 | Manufactured by |
| | | Evonik Industries AG |
| Polymerization | Omnirad TPO | Manufactured by |
| initiator | | IGM Resins B.V. |
| | Irg819, bis(2,4,6-trimethyl | Manufactured by |
| | benzoyl)phenylphosphine | BASF Resins B.V. |
| | oxide | |
| Polymerization | BHT, dibutyl hydroxy toluene | Manufactured by |
| inhibitor | | IGM Resins B.V. |

Aspects of the present disclosure are, for example, as follows.

1. An active energy ray curing composition contains a urethane acrylate oligomer (A) having three or more polymerizable functional groups, a polyfunctional monomer (B) having three or more polymerizable functional groups, a monofunctional monomer (C), and a surfactant (D) having a siloxane bond, wherein the urethane acrylate oligomer (A) has a glass transition temperature of 85 degrees C. or lower, wherein the urethane acrylate oligomer (A) has a weight average molecular weight of from 1,000 to 9,000, wherein the polyfunctional monomer (B) accounts for 22.0 to 60.0 percent by mass of an entire of the active energy ray curing composition.

2. The active energy ray curing composition according to 1 mentioned above, wherein the urethane acrylate oligomer (A) accounts for 3.0 to 10.0 percent by mass of the entire of the active energy ray curing composition.

3. The active energy ray curing composition according to 1 or 2 mentioned above, wherein the polyfunctional monomer (B) accounts for 22.0 to 45.0 percent by mass of the entire of the active energy ray curing composition.

4. The active energy ray curing composition according to any one of 1 to 3 mentioned above, wherein the monofunctional monomer (C) has a heterocyclic structure.

5. The active energy ray curing composition according to any one of 1 mentioned above, wherein the monofunctional monomer (C) accounts for 10.0 to 45.0 percent by mass of the entire of the active energy ray curing composition.

6. The active energy ray curing composition according to any one of 1 to 5 mentioned above further contains two or more types of polyfunctional monomers.

7. The active energy ray curing composition according to any one of 1 to 6 mentioned above, wherein the urethane acrylate oligomer (A) has a weight average molecular weight of from 1,000 to 4,000.

8. The active energy ray curing composition according to any one of 1 to 7 mentioned above, wherein the urethane acrylate oligomer (A) has a glass transition temperature of from 31 to 85 degrees C.

9. The active energy ray curing composition according to any one of 1 to 8 mentioned above, wherein the surfactant (D) has four or less polymerizable functional groups.

10. An active energy ray curing ink composition contains the active energy ray curing composition of any one of 1 to 9 mentioned above. 11. An active energy ray curing inkjet ink composition contains the active energy ray curing ink composition of 10 mentioned above.

12. A composition container contains a container containing the active energy ray curing composition of any one of 1 to 9 mentioned above, the active energy ray curing ink composition of 10 mentioned above, or the active energy ray curing inkjet ink composition of 11 mentioned above.

13. An apparatus for forming a two-dimensional or three-dimensional image includes an accommodating unit containing the active energy ray curing composition of any one of 1 to 9 mentioned above, the active energy ray curing ink composition of 10 mentioned above, or the active energy ray curing inkjet ink composition of 11 mentioned above; and an irradiator configured to emit active energy ray.

14. A method of forming a two-dimensional or three-dimensional image includes exposing the active energy ray curing composition of any one of 1 to 9 mentioned above, the active energy ray curing ink composition of 10 mentioned above, or the active energy ray curing inkjet ink composition of 11 mentioned above to active energy ray.

15. Cured matter produced by a method of exposing the active energy ray curing composition of any one of 1 to 9 mentioned above, the active energy ray curing ink composition of 10 mentioned above, or the active energy ray curing inkjet ink composition of 11 mentioned above to active energy rays.

16. A decorated object having a substrate having a surface decorated with the processed product of 15 mentioned above.

17. The decorative object according to 16 mentioned above, wherein the decorative object has a cylindrical form.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An active energy ray curing composition, comprising:
a urethane acrylate oligomer (A) having three or more polymerizable functional groups;
a polyfunctional monomer (B) having three or more polymerizable functional groups;
a monofunctional monomer (C); and
a surfactant (D) having a siloxane bond,
wherein the urethane acrylate oligomer (A) has a glass transition temperature of 85 degrees C. or lower,
wherein the urethane acrylate oligomer (A) has a weight average molecular weight of from 1,000 to 9,000,
wherein the polyfunctional monomer (B) accounts for 22.0 to 60.0 percent by mass of an entire of the active energy ray curing composition.

2. The active energy ray curing composition according to claim 1, wherein the urethane acrylate oligomer (A) accounts for 3.0 to 10.0 percent by mass of the entire of the active energy ray curing composition.

3. The active energy ray curing composition according to claim 1, wherein the polyfunctional monomer (B) accounts for 22.0 to 45.0 percent by mass of the entire of the active energy ray curing composition.

4. The active energy ray curing composition according to claim 1, wherein the monofunctional monomer (C) has a heterocyclic structure.

5. The active energy ray curing composition according to claim 1, wherein the monofunctional monomer (C) accounts for 10.0 to 45.0 percent by mass of the entire of the active energy ray curing composition.

6. The active energy ray curing composition according to claim 1, further comprising two or more types of polyfunctional monomers.

7. The active energy ray curing composition according to claim 1, wherein the urethane acrylate oligomer (A) has a weight average molecular weight of from 1,000 to 4,000.

8. The active energy ray curing composition according to claim 1, wherein the urethane acrylate oligomer (A) has a glass transition temperature of from 31 to 85 degrees C.

9. The active energy ray curing composition according to claim 1, wherein the surfactant (D) has four or less polymerizable functional groups.

10. An active energy ray curing ink composition, comprising:
the active energy ray curing composition of claim 1.

11. An active energy ray curing inkjet ink composition, comprising:
the active energy ray curing ink composition of claim 10.

12. A composition container, comprising:
a container containing the active energy ray curing composition of claim 1, an active energy ray curing ink composition comprising the active energy ray curing composition, or an active energy ray curing inkjet ink composition comprising the active energy ray curing ink composition.

13. An apparatus for forming a two-dimensional or three-dimensional image, comprising:
an accommodating unit containing the active energy ray curing composition of claim 1, an active energy ray curing ink composition comprising the active energy ray curing composition, or the active energy ray curing inkjet ink composition comprising the active energy ray curing ink composition; and
an irradiator configured to emit active energy rays.

14. A method of forming a two-dimensional or three-dimensional image, comprising:
exposing the active energy ray curing composition of claim 1, an active energy ray curing ink composition comprising the active energy ray curing composition, or an active energy ray curing inkjet ink composition comprising the active energy ray curing ink composition to active energy rays.

15. Cured matter produced by a method of exposing the active energy ray curing composition of claim 1, an active energy ray curing ink composition comprising the active energy ray curing composition, or an active energy ray curing inkjet ink composition comprising the active energy ray curing ink composition to active energy rays.

16. A decorative object, comprising:
a substrate; and
a surface decoration of the cured matter of claim 15 on the substrate.

17. The decorative object according to claim 16, wherein the decorative object has a cylindrical form.
